(19) United States
(12) Patent Application Publication
(10) Pub. No.: US 2016/0076295 A1
(43) Pub. Date: Mar. 17, 2016

(54) Foot Pedal Door Opener

(71) Applicant: Daniel Boyd, Seattle, WA (US)

(72) Inventor: Daniel Boyd, Seattle, WA (US)

(21) Appl. No.: 14/857,079

(22) Filed: Sep. 17, 2015

Related U.S. Application Data
(60) Provisional application No. 62/051,608, filed on Sep. 17, 2014.

(51) Int. Cl. E05F 13/02

(52) U.S. Cl. CPC E05F 13/02

(57) ABSTRACT

A foot pedal door opener adapted to allow a user to more easily open the door of a refrigerator in a hands-free manner. The door opener provides a lever that pivots about a bar and is disposed between a pair of brackets that also pivot about the bar. A pedal is disposed on the lever and provides a foot support and a shaft. A band extends along and around the lever and the pair of brackets to provide resistance thereto. The user can manually step on the foot support, applying pressure thereto, wherein the pressure moves the lever from a resting position to a working position such that the lever pushes the refrigerator door open for the user. The foot pedal door opener can be mounted to the bottom of a refrigerator via an adhesive or other fasteners.

### CROSS REFERENCE TO RELATED APPLICATION

This application claims the benefit of U.S. Provisional Application No. 62/051,608 filed on Sep. 17, 2014. The above identified patent application is herein incorporated by reference in its entirety to provide continuity of disclosure.

### BACKGROUND OF THE INVENTION

### Field of the Invention

The present invention relates to a foot pedal. More specifically, the invention relates to foot actuated device that can be mounted to the bottom of a refrigerator, wherein the device provides a pivotable lever, brackets, and a foot support that can be utilized to open the door of a refrigerator in a hands-free manner.

It can be quite difficult to open a refrigerator door when holding a baby, talking on the phone or carrying groceries and other various items. Some people may be in the middle of cooking and may not wish to soil the refrigerator handle with foodstuffs on their hands. In such circumstances as described above, it can be quite a task to attempt to open a refrigerator door in a hands-free manner.

Some apparatuses intended to help a user with opening the refrigerator door provide a side-mounted pedal, however such devices require the user to move to the end of the refrigerator and does not allow a user to have straightway access to the interior of a fridge. This can be less than inefficient. Other devices provide foot pedals that are positioned in front of a door but employ several different mechanical components that can become ineffective overtime and cannot be easily removed from a refrigerator when desired. This can be especially frustrating when purchasing a new refrigerator.

In light of the devices disclosed in the prior art, it is submitted that the present invention substantially diverges in design elements from the prior art and consequently it is clear that there is a need in the art for an improvement to existing refrigerator door opening devices. Thus, there exists a need for a new and improved foot pedal door opener that is adapted for a refrigerator door, wherein the device provides a movable lever, foot support and adhesive for mounting to the bottom of a refrigerator.

### SUMMARY OF THE INVENTION

In view of the foregoing disadvantages inherent in the known types of foot pedals adapted for opening doors now present in the prior art, the present invention provides a new refrigerator foot pedal door opener, wherein the same can be utilized for providing convenience for the user when opening the door of a refrigerator in a hands-free manner.

It is therefore an object of the present invention to provide a new and improved foot pedal door opener that has all of the advantages of the prior art and none of the disadvantages.

It is another object of the present invention to provide a foot pedal door opener that can be mounted to the lower end of a refrigerator.

Another object of the present invention is to provide a foot pedal door opener Comprising one or more brackets removably securable to a refrigerator, wherein a lever is pivotally attached to said brackets and that is adapted to open said refrigerator door when a shaft and foot support connected to said lever are actuated donwardly.

Yet another object of the present invention is to provide a foot pedal door opener that can be especially helpful for children and those less able to open a refrigerator door.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the foot pedal door opener.

FIG. 2 shows a view of the foot pedal door opener in use with a refrigerator.

### DETAILED DESCRIPTION OF THE INVENTION

Reference is made herein to the attached drawings. Like reference numerals are used throughout the drawings to depict like or similar elements of the foot pedal door opener. For the purposes of presenting a brief and clear description of the present invention, the preferred embodiment will be discussed as used for opening the door of a refrigerator in a hands-free manner. The figures are intended for representative purposes only and should not be considered to be limiting in any respect.

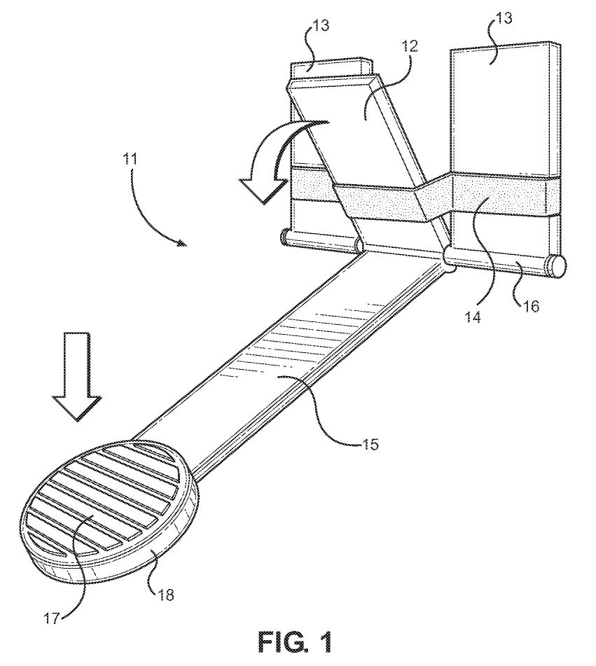

Referring now to FIG. 1, there is shown a perspective view of the foot pedal door opener 11 in an actuated position, wherein the foot support 18 has been depressed. The present invention provides a foot pedal door opener 11 that is adapted to open the door of a refrigerator. The foot pedal door opener 11 comprises one or more mounting brackets 13 having a lever 12 pivotally secured thereto. In the illustrated embodiment, the lever 12 is disposed between a pair of mounting brackets 13. The brackets 13 comprise a rectangular shape in a preferred embodiment and are disposed in a vertical orientation. There is a lever 12 located in between the pair of brackets 13 that is preferably rectangular shape and that is disposed in a vertical orientation. The lever 12 is aligned with the pair of brackets 13 in a resting configuration.

The lever 12 provides a first side, a second side, a first end and a second end and is substantially planar in structure. The lever 12 is integrally connected to a pedal having a foot support 18. The pedal comprises a shaft 15 having a first end, wherein the first end is connected to the second end of the lever 12 and is integral therewith forming a unitary structure. The shaft 15 is substantially perpendicular to the lever 12, so that in the resting configuration the lever 12 is in a vertical orientation and the shaft 15 is in a horizontal orientation. The shaft 15 further comprises a second end, wherein the second end provides a foot support 18. The foot support 18 provides a circular shape in a preferred embodiment. An upper surface of the foot support 18 provides a plurality of ridges 17, wherein the ridges 17 are adapted to provide friction when the user applies pressure thereon, typically by stepping onto the foot support 18. The ridges 17 are lineated strips disposed in a parallel relation to one another.

The foot pedal door opener 11 further comprises a resistance mechanism 14 that helps to provide resistance against movement of the pedal. The resistance mechanism 14 also causes the device to return to a resting configuration after the foot pedal has been depressed and has been placed in the working orientation. In the illustrated embodiment, the resistance mechanism 14 comprises a band that is disposed across the pair of brackets 13 and the lever, wherein the band comprises a horizontally oriented strip of a flexible material such as rubber that extends across the first side of the pair of brackets 13 and the first side of the lever. The band can extend across the first side of the pair of brackets 13 and the first side of the lever 12 in one embodiment, wherein another embodiment can provide a structure in which the band extends across the first side of the pair of brackets 13, the first side of the lever 12 and along the second side of the pair of brackets 13 and the second side of the lever, thus encircling the pair of brackets 13 and the lever therearound. The band applies resistance to the lever 12 and enables the lever 12 to rotate from a resting position to a working position.

The pair of brackets 13 and the lever 12 each and individually provide a channel at the base thereof, wherein the channel of each of the pair of brackets 13 and the lever 12 are substantially the same having a hollow interior and open ends. A bar 16 having a tubular construction extends through the open ends of the pair of brackets 13 and the lever 12, thus connecting the pair of brackets 13 and the lever 12 in a linear fashion by which the pair of brackets 13 and the lever 12 are adjacent to another and the lever 12 is adapted to rotate about the bar 16 angularly in a single plane.

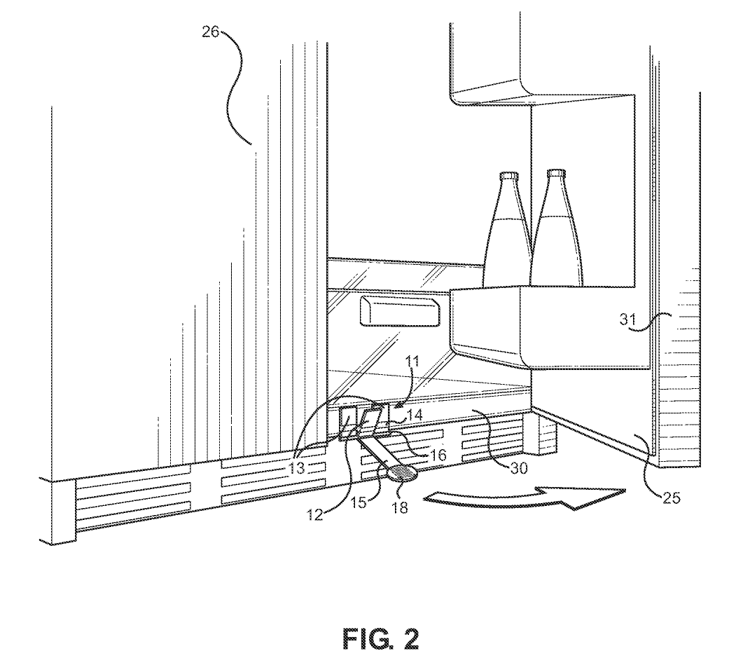

Referring now to FIG. 2, there is shown a view of the foot pedal door opener 11 mounted onto the lower end of a refrigerator 26. The foot pedal door opener 11 can be attached to the lower end 30 of a standard refrigerator 26 having a front side, a back side, a door with a first side and a second side, an interior volume, and a base. The foot pedal door opener 11 can be mounted to the front side of the refrigerator 26 at the bottom thereof between the second side of the door and the interior volume of the refrigerator 26. When the foot pedal door opener 11 is in a resting position, the lever 12 is flush with the pair of brackets 13 disposed on either side thereof. When the lever 12 is in a working position, the lever 12 is in an angular position in relation to the pair of brackets 13 on either side thereof, wherein the lever 12 pivots about the bar 16 from a resting position to a working position.

The second side of the pair of brackets 13 and the lever 12 provides an adhesive in a preferred embodiment, wherein the adhesive is covered by a pull-back film. The user can remove the pull-back film when ready to use the device, thus revealing the adhesive thereunder. The user can then place the adhesive area onto a front surface of the refrigerator 26 at the bottom thereof, such that the foot pedal door opener 11 will contact the second side 25 of the refrigerator door 31 at the bottom thereof when the refrigerator door 31 is in closed position and will lay flush thereagainst.

The user can proceed to close the refrigerator door 31 to which the front side of the lever 12 and the pair of brackets 13 contact the second side 25 of the refrigerator door 31. The shaft 15 and the foot support 18 extend perpendicularly from the lever 12 in a perpendicular orientation therefrom, wherein the shaft 15 and the foot support 18 further extend from the second side of the refrigerator door 31 to the first side of the refrigerator door 31 along the bottom thereof. Thus, in a resting position, the foot support 18 of the foot pedal door opener 11 is located proximally from the first side of the refrigerator door 31 such that it is disposed in such a way as to allow room for a user to step thereon to the foot support 18.

Once, the user steps onto the foot support 18, applying pressure thereto, the lever 12 then moves pivotally towards the second side of the door 31 and proximally from the pair of brackets 13. This is accomplished by way of the pivotable attachment to the bar 16 and the resistance of the band 14. As the user steps on the foot support 18, the lever 12 contacts the second side 25 of the door 31 pushing it away from the interior volume of the refrigerator 26, thus pushing it open for the user to gain access to the interior of the refrigerator 26. When the user has finished their use with the interior contents of the refrigerator 26, the user can walk away as usual, while gravity cause the refrigerator door 31 to begin closing and thus contacting the first side of the lever 12, pushing it back to its resting position adjacent to the pair of brackets 13, wherein the shaft 15 and foot support 18 return to a ninety degree angle in relation to the lever 12 and extend proximally from the lever and to the first side of the refrigerator door 31.

The foot pedal door opener 11 can be constructed from any of various materials including but not limited to plastic, metal, stainless steel, wood, and/or other suitable materials. In an alternative embodiment, there need not be an adhesive in order to enable the foot pedal door opener 11 to be mounted to a refrigerator 26 but may be other types of fasteners such as hooks, nails, screws and/or other suitable fasteners.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A foot pedal door opener comprising:
at least one bracket removably securable to a lower end of a refrigerator;
a lever pivotally secured to said at least one bracket and movable between a resting position and a working position;
a foot pedal comprising a shaft and a foot support, wherein said shaft is affixed to said lever in a perpendicular orientation, wherein an end of said shaft comprises said foot support thereon;
wherein application of pressure to said foot support causes said lever to contact an interior portion of a door of said refrigerator in order to open said door.

2. The foot pedal door opener of claim 1, wherein said at least one bracket is a pair of brackets.

3. The foot pedal door opener of claim 1, wherein said at least one bracket comprises a substantially rectangular shape.

4. The foot pedal door opener of claim 1, wherein said second side of at least one bracket comprises a fastener disposed thereon.

5. The foot pedal door opener of claim 4, wherein said fastener of said second side of said bracket is an adhesive.

6. The foot pedal door opener of claim 1, wherein said lever is substantially rectangular in shape.

7. The foot pedal door opener of claim 2, wherein said pair of brackets is substantially rectangular in shape.

8. The foot pedal door opener of claim 1, further comprising a resistance mechanism for providing resistance to movement of said lever.

9. The foot pedal door opener of claim 8, wherein said resistance mechanism comprises a band that extends across said at least one bracket and that further extends across said lever to resist movement thereof.

10. The foot pedal door opener of claim 1, wherein said foot support further comprises ridges disposed thereon for friction.
